(19) United States
(12) Patent Application Publication
(10) Pub. No.: US 2021/0342977 A1
(43) Pub. Date: Nov. 4, 2021

(54) Method And Apparatus For Image Restoration, Storage Medium And Terminal

(71) Applicant: Shanghai Harvest Intelligence Technology Co., Ltd., Shanghai (CN)

(72) Inventor: Chuan XIA, Shanghai (CN)

(73) Assignee: Shanghai Harvest Intelligence Technology Co., Ltd., Shanghai (CN)

(21) Appl. No.: 17/244,474

(22) Filed: Apr. 29, 2021

(30) Foreign Application Priority Data
Apr. 29, 2020 (CN) 202010357097.7

(51) Int. Cl. G06T 5/00; G06K 9/62

(52) U.S. Cl. CPC G06T 5/001; G06T 5/009; G06T 2207/20084; G06K 9/6298; G06T 5/006

(57) ABSTRACT

The present disclosure provides an method and apparatus for image restoration, a storage medium and a terminal. The method includes: acquiring a to-be-processed image including biometric information; inputting the to-be-processed image into a generator, wherein the generator comprises a neural network model with a plurality of convolutional layers, and a weight of a convolutional kernel of the generator is determined at least according to a quality of an image historically restored by the generator; and restoring the to-be-processed image by the generator to acquire a restored image. The present disclosure can effectively improve a restoration quality when performing image restoration based on machine learning.

### CROSS-REFERENCE TO RELATED APPLICATIONS

The present application claims the benefit of priority to Chinese patent application No. 202010357097.7, filed on Apr. 29, 2020, entitled “Method and Apparatus for Image Restoration, Storage Medium and Terminal”, the entire disclosures of which are incorporated herein by reference.

### TECHNICAL FIELD

The present disclosure relates to the technical field of image processing, and more particularly to a method and apparatus for image restoration, a storage medium and a terminal.

### BACKGROUND

In existing technology, when an under-screen optical fingerprint imaging is captured, if an imaging of a fingerprint on a sensor just falls into a signal saturation area of the sensor, texture information of the fingerprint will be lost. Further, as an incident angle of light increases, a transmission path of the light with fingerprint information before reaching the sensor increases accordingly, which results in a weakening of an actual optical signal received by a sensor. When the incident angle increases to a certain angle, a signal-to-noise ratio of the optical signal received by the sensor is too small to be detected to form a clear fingerprint image.

Therefore, restoring fingerprint images captured by the sensor has become a major research focus in the field of fingerprint acquisition technology.

### SUMMARY

The present disclosure provides an improved restoration method, which can improve a restored image quality when performing image restoration based on machine learning.

An embodiment of the present disclosure provides a method for image restoration. The method may include: acquiring a to-be-processed image, wherein the to-be-processed image includes biometric information; inputting the to-be-processed image into a generator, wherein the generator includes a neural network model with a plurality of convolutional layers, and a weight of a convolutional kernel of the generator is determined at least according to a quality of an image historically restored by the generator; and restoring the to-be-processed image by the generator to acquire a restored image.

In some embodiment, determining a weight of a convolutional kernel of the generator at least according to a quality of an image historically restored by the generator includes: updating the weight of the convolutional kernel of the generator according to an evaluation result of a discriminator on the image historically restored by the generator. The discriminator includes a neural network model with a plurality of convolutional layers.

In some embodiment, there is a connection relationship among the plurality of convolutional layers of the neural network model of the generator and/or the plurality of convolutional layers of the neural network model of the discriminator.

In some embodiment, updating the weight of the convolutional kernel of the generator according to an evaluation result of a discriminator on the image historically restored by the generator includes: acquiring the image historically restored by the generator; inputting the historically restored image into the discriminator; acquiring a first evaluation result of the discriminator on the historically restored image; and updating the weight of the convolutional kernel of the generator at least according to a loss function of the generator and the first evaluation result.

In some embodiment, the loss function of the generator includes an adversarial loss function and an L1 loss function, and updating the weight of the convolutional kernel of the generator at least according to the loss function of the generator and the first evaluation result includes: calculating a first output value according to the first evaluation result and the adversarial loss function of the generator; calculating a second output value according to the historically restored image, a standard image corresponding to the historically restored image and the L1 loss function; and updating the weight of the convolutional kernel of the generator according to the first output value and the second output value.

In some embodiment, calculating a first output value according to the first evaluation result and the adversarial loss function of the generator includes: calculating the first output value based on following formula:

$${L}_{g\_adv} = {max}_{G} ( {E}_{z ∼ p ( z )} [ D ( G ( z ) ) ] ) ;$$

wherein L_{g_adv}, represents the first output value,

$${max}_{G} ( )$$

represents a value or G when the function of E_{z˜p(z)}[D(G(z))] has a maximum value, G represents the generator, the value of G calculated based on the above formula is the first output value; E_{z˜p(z)}(u) represents a mean value of a function u when z obeys P(z), p(z) represents a distribution of the historically restored image, z represents the to-be-processed image, D(G(z)) represents the first evaluation result, and G(z) represents the historically restored image.

In some embodiment, calculating a second output value according to the historically restored image, a standard image corresponding to the historically restored image and the L1 loss function includes: calculating the second output value based on following formula:

L₁=∥x−G(z)∥₁;

wherein L1 represents the second output value, x represents the standard image, z represents the to-be-processed image, and G(z) represents the historically output restored image.

In some embodiment, updating the weight of the convolutional kernel of the discriminator according to an evaluation result of the discriminator on the image historically restored by the generator and a standard image corresponding to the historically restored image.

In some embodiment, updating the weight of the convolutional kernel of the discriminator according to an evaluation result of the discriminator on the historically restored image by the generator and a standard image corresponding to the historically restored image includes: acquiring the image historically restored by the generator and the corresponding standard image; inputting the historically restored image into the discriminator to obtain a first evaluation result, and inputting the standard image into the discriminator to obtain a second evaluation result; and calculating a third output value at least according to an adversarial loss function of the discriminator, the first evaluation result and the second evaluation result; and updating the weight of the convolutional kernel of the discriminator according to the third output value.

In some embodiment, calculating a third output value at least according to an adversarial loss function of the discriminator, the first evaluation result and the second evaluation result includes: calculating the third output value based on following formula:

$${L}_{d\_adv} = {min}_{D} ( {E}_{x ∼ q ( x )} [ max ( 0 , 1 - D ( x ) ) ] + {E}_{z ∼ p ( z )} [ max ( 0 , 1 + D ( G ( z ) ) ) ] ) + λ {{E}_{\hat{I} ∼ p \hat{I}} ( {( ‖ {∇}_{\hat{I}} D ( \hat{I} ) ‖ )}^{2} - 1 )}^{2} ;$$

wherein L_{d_adv}, represents the third output value,

$${min}_{D} ( )$$

represents a value of D when the function of E_{x˜q(x)}[max(0,1−D(x))]E_{z˜p(z)}[max(0,1+D(G(z)))] has a minimum value, D represents the discriminator, the value of D calculated based on the above formula represents the third output value, E_{x˜q(x)}(u) represents a mean value of a function u when x obeys q(x), q(x) represents a distribution of the standard image, x represents the standard image, E_{z˜p(z)}(u) represents a mean value of the function u when z obeys p(z), p(z) represents a distribution of the historically restored image, z represents the to-be-processed image, D(x) represents the second evaluation result, D(G(z)) represents the first evaluation result, G(z) represents the historically restored image, λ represents a preset hyperparameter, ∇( ) represents a gradient penalty function, Î represents an interpolation function between the distribution of q(x) and the distribution of p(z), and ∇_{Î}D(Î) represents a gradient penalty of the discriminator by the interpolation function Î between the distribution of q(x) and the distribution of p(z).

In some embodiment, updating the weight of the convolutional kernel of the generator and updating the weight of the convolutional kernel of the discriminator are performed several times.

In some embodiment, the discriminator includes a plurality of residual modules and a self-attention module. The plurality of residual modules are connected in series and configured to receive a feature map of a to-be-evaluated image or a feature map processed by an upper level residual module. The to-be-evaluated image is the image historically restored by the generator or a standard image corresponding to the historically restored image, and each residual module includes one or more convolutional layers. The self-attention module has an input end connected with a residual module of the plurality of residual modules to receive the feature map processed by the residual module. The self-attention module is configured to extract global features of an input feature map, and an output end of the self-attention module is connected with another residual module of the plurality of residual modules.

In some embodiment, one or more of the plurality of residual modules include a channel attention module. The channel attention module is configured to perform a weighting process on channels of the input feature map, and the input feature map is a feature map processed by the one or more convolutional kernels of the residual module.

In some embodiment, the channel attention module includes: a global average pooling unit configured to perform a global average pooling on the input feature map; a linear correction unit configured to perform a linear correction on the feature map on which the global average pooling has been performed; and an s activation function unit configured to determine a weight of each channel according to the feature map on which the linear correction has been performed. Adjacent units are connected through a full connection layer.

In some embodiment, the channel attention module further includes: a first weighted summation unit configured to perform a weighted summation on the input feature map according to the weight of each channel determined by the s activation function unit.

In some embodiment, the input end of the self-attention module is connected with an output end of a second residual module, and the output end of the self-attention module is connected with an input end of a third residual module.

In some embodiment, the self-attention module includes: a query unit, a key unit, a value unit, a self-similarity calculation unit, a normalization processing unit, and a second weighted summation unit. The query unit is configured to perform convolution on the input processed feature map by a query convolutional kernel to obtain a query convolution processing result. The key unit is configured to perform convolution on the input processed feature map by a key convolutional kernel to obtain a key convolution processing result. The value unit is configured to perform convolution on the input processed feature map by a value convolutional kernel to obtain a value convolution processing result. The self-similarity calculation unit is configured to calculate a self-similarity of the query convolution processing result and the value convolution processing result; a normalization processing unit configured to normalize the calculated self-similarity based on a preset regression function to obtain a normalized weight. The second weighted summation unit is configured to perform weighted summation on the value convolution processing result according to the normalized weight to obtain a weighted summation result. The output of the self-attention module is generated according to the weighted summation result.

In some embodiment, the generator processes the to-be-processed image based on partial convolution and/or LBAM.

In some embodiment, the biometric information includes fingerprint or palm print information.

Another embodiment of the present disclosure provides an apparatus for image restoration. The apparatus includes a first acquisition circuitry and a processing circuitry. The first acquisition circuitry is configured to: acquire a to-be-processed image including biometric information, and to input the to-be-processed image into a generator. The processing circuitry includes the generator, and the generator is configured to restore the to-be-processed image and includes a neural network model with a plurality of convolutional layers. A weight of a convolutional kernel of the generator is determined at least according to a quality of an image historically restored by the generator.

Another embodiment of the present disclosure provides a non-transitory storage medium having computer instructions stored therein, wherein the computer instructions are executed to perform steps of the method according to embodiments of the present disclosure.

Another embodiment of the present disclosure provides a terminal including a memory and a processor, wherein the memory is stored with computer instructions executable on the processor, and the computer instructions are executed by the processor to perform steps of the method according to embodiments of the present disclosure.

Compared with conventional technologies, embodiments of the present disclosure have following beneficial effects.

According to an embodiment of the present disclosure, the image restoration method includes: acquiring a to-be-processed image including biometric information; inputting the to-be-processed image into a generator, wherein the generator includes a neural network model with a plurality of convolutional layers, and a weight of a convolutional kernel of the generator is determined at least according to a quality of an image historically restored by the generator; and restoring the to-be-processed image by the generator to acquire a restored image.

Compared with existing solutions of restoring images based on machine learning, embodiments of the present disclosure perform image restoration based on the neural network model, and the convolutional kernel of the neural network model is adjusted according to a historical restoration results to optimize the quality of the restored image output by the generator. Specifically, the process of adjusting the convolutional kernel can at least be implemented in a model training stage according to the quality of the historically restored image of the generator, so as to obtain a generator that is more in line with actual needs. Further, in actual application stage, the convolutional kernel can be further adjusted based on the historically restored images. With the increase of historical data, amount of feedback data for adjusting the convolutional kernel becomes larger and larger, making the adjustment of the convolutional kernel more accurate, which facilitates to improve the restoration quality when performing image restoration based on machine learning.

### BRIEF DESCRIPTION OF THE DRAWINGS

FIG. 1 schematically illustrates a flowchart of a method for image restoration according to an embodiment of the present disclosure;

FIG. 2 schematically illustrates a flowchart of a method for adjusting a convolutional kernel according to an embodiment of the present disclosure;

FIG. 3 illustrates a schematic structural diagram of a residual module according to an embodiment of the present disclosure;

FIG. 4 illustrates a schematic structural diagram of a channel attention module in

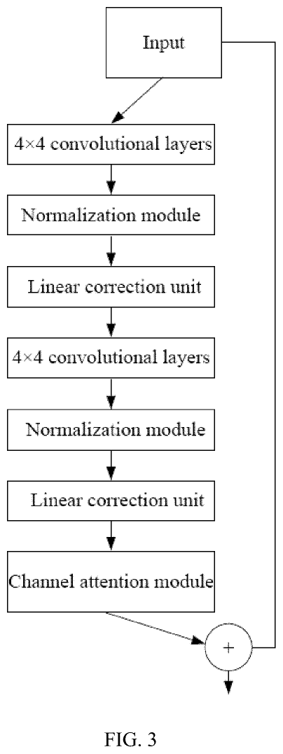

FIG. 3;

FIG. 5 illustrates a schematic structural diagram of a self-attention module according to an embodiment of the present disclosure; and

FIG. 6 illustrates a schematic diagram of an apparatus for image restoration according to an embodiment of the present disclosure.

### DETAILED DESCRIPTION

As mentioned in the background, it is necessary to perform restoration on the collected images in later stage in existing fingerprint collection solutions.

An intuitive solution is to image multiple times, complement each other, and combine multiple collected images to obtain a complete image. However, in practical applications, fingerprint unlocking time of a mobile phone is very short, and multiple imaging scheme has very high requirements on a processing speed of a hardware of the mobile phone, which increases system cost.

An embodiment of the present disclosure provides a method for image restoration. The method includes: acquiring a to-be-processed image including biometric information; inputting the to-be-processed image into a generator, wherein the generator includes a neural network model with a plurality of convolutional layers, and a weight of a convolutional kernel of the generator is determined at least according to a quality of an image historically restored by the generator, and restoring the to-be-processed image by the generator to acquire a restored image.

Embodiments of the present disclosure perform image restoration based on the neural network model, and the convolutional kernel of the neural network model is adjusted according to a historical restoration results to optimize the quality of the restored image output by the generator. Specifically, the process of adjusting the convolutional kernel can at least be implemented in a model training stage according to the quality of the historically restored image of the generator, so as to obtain a generator that is more in line with actual needs. Further, in actual application stage, the convolutional kernel can be further adjusted based on the historically restored images. With the increase of historical data, amount of feedback data for adjusting the convolutional kernel becomes larger and larger, making the adjustment of the convolutional kernel more accurate, which facilitates to improve the restoration quality when performing image restoration based on machine learning.

In order to make above objects, features and beneficial effects of the present disclosure more obvious and understandable, specific embodiments of the present disclosure are described in detail in combination with the drawings.

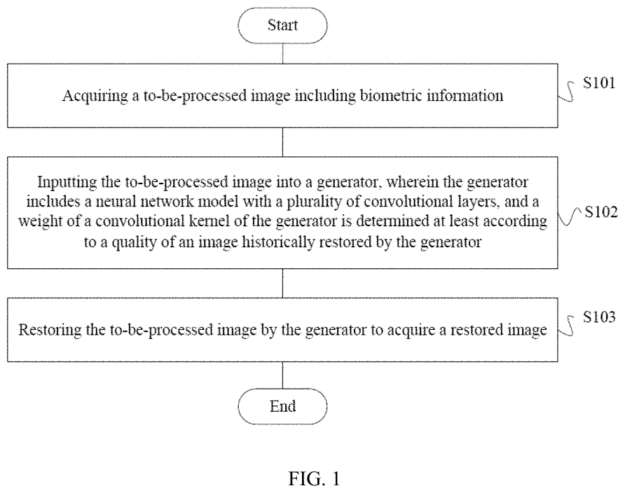

FIG. 1 is a flow chart of a method for image restoration according to an embodiment of the present disclosure.

Specifically, referring to FIG. 1, the method may include following steps:

S101, acquiring a to-be-processed image including biometric information.

S102, inputting the to-be-processed image into a generator, wherein the generator includes a neural network model with a plurality of convolutional layers, and a weight of a convolutional kernel of the generator is determined at least according to a quality of an image historically restored by the generator.

S103, restoring the to-be-processed image by the generator to acquire a restored image.

In some embodiment, the biometric information may include fingerprint or palm print information. Next, an image containing fingerprint information is taken as an example for specific description.

In some embodiment, in S101, the to-be-processed image may be collected by a sensor. For example, the sensor can be integrated into an intelligent terminal such as a mobile phone and iPad. The method in this embodiment can be executed by a processor of the intelligent terminal, or by a background server communicating with the intelligent terminal. The background server can be a cloud server.

In some embodiment, the generator may process the to-be-processed image based on partial convolution (PConv).

For example, the neural network model of the generator may be a U-net network structure model. Specifically, for an input to-be-processed image, the U-net network structure model first performs down-sampling on the to-be-processed image by different degrees of convolutional kernel. This process may also be called encoding process to learn deep features of the image. Then, the feature of the image is restored by up-sampling. This process may be called decoding process.

In the up-sampling, both the feature from the up-sampling (i.e., the feature of a decoder) and the feature from the down-sampling (i.e., the feature of the encoder) are received. For example, the (i+1)th convolutional layer may establish a connection channel (referred to as a channel) with the ith convolutional layer and the (n-i)th convolutional layer.

Correspondingly, each convolutional layer starting from the second layer can receive data output by at least one upper convolutional layer.

For each convolutional layer, the convolutional layer convolves the input to-be-processed image, and also convolves a mask corresponding to the input to-be-processed image. The mask characterizes whether each pixel of the to-be-processed image needs to be restored, for example, 1 indicates no restoration is needed, and 0 indicates restoration is needed.

For the generator using partial convolution, the mask and image are updated every time data passes through one convolutional layer, where the data refers to image feature data (i.e., the feature) after convolution of a current convolutional layer. As the number of neural network layers increases, the number of pixels with a value of 0 in the output of a mask m′ becomes less and less, and an area of an effective region in a corresponding restored image x′ becomes larger and larger, thus the impact of the mask on the overall loss will become smaller and smaller.

Finally, a Tanh hyperbolic function can be used as a last activation function. A value of Tanh ranges from −1 to 1, and the Tanh hyperbolic function has a convergence faster than that of S activation function (sigmoid), and symmetrically distributed results.

For example, the restored image x′ and the updated mask m′ can be obtained based on the following formula:

$${x}^{′} = \{ \begin{matrix}{W}^{T} ( X ⊙ M ) \frac{sum ( 1 )}{sum ( M )} + b , & ifsu m ( M ) > 0 \\ 0 , & otherwise\end{matrix} ; \\ {m}^{′} = \{ \begin{matrix}1 , & ifsu m ( M ) > 0 \\ 0 , & otherwise\end{matrix} ;$$

wherein, W represents the convolutional kernel of the convolutional layer, that is, the weights of filters of the convolutional layer, T represents a transposition of a matrix, X represents feature values of the input image, M represents the mask, and is a binary mask in this embodiment, 0 represents a unit multiplication, that is, an element-wise dot multiplication operation, b represents a bias of the filters of the convolutional layer, m′ represents an output of the input mask after convolution. For each convolutional layer, the restored image x′ output by the convolutional layer is an output image after convolution by the convolutional layer. Similarly, for each convolutional layer, the updated mask m′ output by the convolutional layer is an output mask after convolution by the convolutional layer.

Specifically, the convolutional kernel W may be used to determine the number of features to be extracted from the input image.

In some embodiment, the generator may process the to-be-processed image based on learnable bidirectional attention maps (LBAM, referred to as a learnable bidirectional mask).

For example, in the above-mentioned PConv-based U-net network structure model, the process of updating the mask may only occur in the encoding stage. In the decoding stage, all values of the mask are 1.

In some embodiment, the learnable bidirectional attention map can be introduced into a LBAM model. Suppose that X is the input image and M is the corresponding mask, 1 represents a pixel with valid fingerprint information, and 0 represents a pixel without valid fingerprint information.

In forward attention mask, M is used as an input mainly used to modify the features during encoding. In the encoding stage, the value of the mask is gradually updated, and the features are corrected with the mask during the encoding.

In contrast, in the decoding stage, 1−M is used as the mask of the last layer to modify the features of the last layer in the decoder. Further, the previous layer mask in the decoder is gradually updated forward, and the corresponding mask is used to modify the features of the previous layer in the decoder.

In some embodiment, a bidirectional attention mask is adopted so that the decoder can pay more attention to how to restore areas without fingerprints. Therefore, by adopting the bidirectional attention mask, irregular areas without fingerprints can be better restored.

Specifically, in the encoding stage, down-sampling is performed based on following formulas (1) to (3):

M_{C}ⁱⁿ=g_{A}(Wₘ^{T}Mⁱⁿ) (1);

F^{out}=(W_{f}^{T}Fⁱⁿ)⊙M_{C}ⁱⁿ (2);

M^{out}=gₘ(M_{C}ⁱⁿ) (3);

wherein, Mⁱⁿ represents the input mask of the current layer in the encoder, Wₘ^{T} represents the convolutional kernel of the corresponding updated mask M_{C}ⁱⁿ, function g_{A}( ) represents an asymmetric activation function with a similar shape to the Gaussian function, function gₘ ( ) represents an activation function for updating the mask, F^{out} represents the output feature of the current layer in the encoder, that is, the input feature of the next layer, Fⁱⁿ represents the input feature of the current layer in the encoder, W_{f}^{T} represents a corresponding convolutional kernel; ⊙ represent a dot multiplication operation, and M^{out} represents the output mask of the current layer in the encoder, that is, the input mask of the next layer.

The function g_{A}( ) may be indicated by following formula:

$${g}_{A} ( {M}^{c} ) = \{ \begin{matrix}a exp ( - {{γ}_{l} ( {M}^{c} - μ )}^{2} ) \\ 1 + ( a - 1 ) exp ( - {{γ}_{r} ( {M}^{c} - μ )}^{2} )\end{matrix} ;$$

wherein, a, μ, γ₁, and γᵣ are constants. In some embodiment, a is 1.1, μ is 2.0, γ₁ is 1.0, and γᵣ is 1.0.

The function gₘ( ) may be indicated by following formula:

gₘ(M^{c})=(ReLU(M^{c}))^{α};

wherein, function ReLU(*) is a linear correction function, and a value less than 0 is set to 0. In some embodiment, α is 0.8.

In the decoding stage, the (L-l)th layer in the decoder receives the feature and the mask of the (l+1)th layer in the encoder, and also receives the features and masks of the (L-l-1)th layer in the decoder. Thus, more attention can be paid to restoring the areas needed to be restored in the (L-l)th layer. Specifically, it can be expressed based on formulas (4) and (5):

F_{d}^{out}=(Wₑ^{T}Fₑⁱⁿ)⊙g_{A}(Mₑ^{c})+(W_{d}^{T}F_{d}ⁱⁿ)⊙g_{A}(M_{d}^{c}) (4);

M_{d}=gₘ(M_{d}^{c}) (5),

wherein Wₑ^{T} and W_{d}^{T} represents corresponding convolutional kernels, Mₑ^{c} and Fₑⁱⁿ respectively represents the mask and the feature of the (l+1)th layer in the encoder, M_{d}^{c} and F_{d}ⁱⁿ respectively represents the mask and the feature of the (L-l-1)th layer in the decoder, and F_{d}^{out} and M′_{d} respectively represents the mask and the feature output by the (L-l)th layer in the decoder.

With above solution, both the mask in the encoding stage and the mask in the decoding stage are considered in the decoding stage. Specifically, in the decoding stage, the mask is updated reversely, and the updated mask is used for the previous layer in the decoder, and in the encoding phase, the updated mask is used for the next layer in the encoder. In this way, the model can pay more attention to the areas to be restored.

In some embodiment, after S103, the method also include following step: calculating L1 loss function and adversarial loss function of the restored image compared with the corresponding standard image.

The L1 loss function L1 loss of the restored image compared with the corresponding standard image can be calculated based on following formula:

L₁=∥G(z)−x∥₁;

wherein, L1 represents the L1 loss function L1_loss, G(z) represents the restored image output by the generator, z represents the to-be-processed image, and x represents the standard image.

In some embodiment, in S103, the restored image output by the generator can be transmitted to a corresponding module of the intelligent terminal for subsequent operation, such as fingerprint unlocking operation.

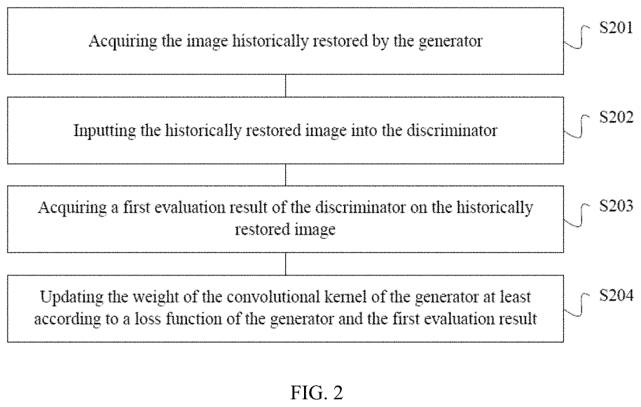

Then, the detailed process of adjusting the convolutional kernel W in the above formulas based on historical data will be described in detail. Referring to FIG. 2, a flowchart of a method for adjusting the convolutional kernel according to an embodiment of the present disclosure is shown.

Specifically, the weight of the convolutional kernel of the generator can be updated according to an evaluation result of a discriminator on the image historically restored by the generator. The discriminator includes a neural network model with a plurality of convolutional layers.

In some embodiment, there is a connection relationship among the plurality of convolutional layers of the neural network model of the generator and/or the plurality of convolutional layers of the neural network model of the discriminator.

Specifically, the weight of the convolutional kernel of the generator can be updated according to a evaluation result of a discriminator on the image historically restored by the generator by following steps.

S201, acquiring the image historically restored by the generator.

S202, inputting the historically restored image into the discriminator.

S203, acquiring a first evaluation result of the discriminator on the historically restored image.

S204, updating the weight of the convolutional kernel of the generator at least according to a loss function of the generator and the first evaluation result.

In some embodiment, in S201, the generator can establish a connection channel with the discriminator to transmit the restored image. Specifically, the restored image output by the generator can be regarded as the historically restored image.

In some embodiment, the discriminator can be used to determine an adversarial loss function of the generator to judge the quality of the image restored by the generator.

For example, the restored image finally output by the generator and the corresponding standard image can be input into the discriminator, and the discriminator can output an image difference degree between the two images. The image difference degree can be used to measure the restoration quality of the image. Specifically, the discriminator can distinguish the restored image from the corresponding standard image. When the discriminator cannot distinguish whether the image is the restored image or the corresponding standard image, the quality of the restored image is the best. In some embodiments, peak signal to noise ratio (PSNR) and structure similarity (SSIM) can be used to judge the quality of the restored image.

In some embodiments, in S202, the historically restored image of 256×256 and the corresponding standard image are input into the first layer of convolutional layer in the discriminator with one channel.

Furthermore, for the plurality of convolutional layers in the discriminator, the number of convolutional kernels of each convolutional layer is gradually increased. That is to say, with a downward transmission of the image, the number of the convolutional kernels is increased. A feature matrix is extracted from each layer, and the last layer calculates the image difference degree to give an evaluation value of the discriminator. For example, the number of the convolutional kernels doubles for each layer of downward transmission.

In some embodiment, the loss function of the generator may include an adversarial loss function and an L1 loss function.

In some embodiment, S204 may include following steps: calculating a first output value according to the first evaluation result and the adversarial loss function of the generator, calculating a second output value according to the historically restored image, a standard image corresponding to the historically restored image and the L1 loss function; and updating the weight of the convolutional kernel of the generator according to the first output value and the second output value.

For example, the first output value can be calculated based on following formula:

$${L}_{g\_adv} = {max}_{G} ( {E}_{z ∼ p ( z )} [ D ( G ( z ) ) ] ) ;$$

wherein, L_{g_adv} represents the first output value

$${max}_{G} ( )$$

represents a value of G when the function of E_{z˜p(z)}[D(G(z))] has a maximum value, G represents the generator, the value of G calculated based on the above formula is the first output value; E_{z˜p(z)}(u) represents a mean value of a function u when z obeys P(z), p(z) represents a distribution of the historically restored image, z represents the to-be-processed image, D(G(z)) represents the first evaluation result, and G(z) represents the historically restored image.

For example, the second output value can be calculated based on following formula:

L₁=∥x−G(z)∥₁;

wherein, L1 represents the second output value (i.e., the L1 loss function), x represents the standard image, z represents the to-be-processed image, and G(z) represents the historically restored image.

Furthermore, the weight of the convolutional kernel of the generator can be updated according to the sum of the first output value and the second output value.

In some embodiments, the weight of the convolutional kernel of the discriminator can also be updated according to an evaluation result of the discriminator on the historically restored image of the generator and a standard image corresponding to the historically restored image.

Before/after/at the same time of S204, the method also includes following steps: acquiring the image historically restored by the generator and the corresponding standard image; inputting the historically restored image into the discriminator to obtain a first evaluation result, and inputting the standard image into the discriminator to obtain a second evaluation result, and calculating a third output value at least according to an adversarial loss function of the discriminator, the first evaluation result and the second evaluation result, and updating the weight of the convolutional kernel of the discriminator according to the third output value.

For example, the third output value can be calculated based on following formula:

$${L}_{d\_adv} = {min}_{D} ( {E}_{x ∼ q ( x )} [ max ( 0 , 1 - D ( x ) ) ] + {E}_{z ∼ p ( z )} [ max ( 0 , 1 + D ( G ( z ) ) ) ] ) + λ {{E}_{\hat{I} ∼ p \hat{I}} ( {( ‖ {∇}_{\hat{I}} D ( \hat{I} ) ‖ )}^{2} - 1 )}^{2} ;$$

wherein, L_{d_adv} represents the third output value,

$${min}_{D} ( )$$

represents a value of D when the function of E_{x˜q(x)}[max(0,1−D(x))]E_{z˜p(z)}[max(0,1+D(G(z)))] has a minimum value, D represents the discriminator, the value of D calculated based on the above formula represents the third output value, E_{x˜q(x)}(u) represents a mean value of a function u when x obeys q(x), q(x) represents a distribution of the standard image, x represents the standard image, E_{z˜p(z)}(u) represents a mean value of the function u when z obeys p(z), p(z) represents a distribution of the historically restored image, z represents the to-be-processed image, D(x) represents the second evaluation result, D(G(z)) represents the first evaluation result, G(z) represents the historically restored image, λ represents a preset hyperparameter, ∇( ) represents a gradient penalty function, Î represents an interpolation function between the distribution of q(x) and the distribution of p(z), and ∇_{Î}D(Î) represents a gradient penalty of the discriminator by the interpolation function between the distribution of q(x) and the distribution of p(z).

In some embodiment, the weight of the convolutional kernel of the discriminator can be updated based on previous steps, and then S202 is executed to input the historically restored mage into the updated discriminator.

In some embodiment, the steps of updating the weight of the convolutional kernel of the generator and updating the weight of the convolutional kernel of the discriminator may be performed several times to train the generator and the discriminator iteratively until the difference between the first evaluation result and the second evaluation result falls into a preset tolerance range.

In some embodiment, the discriminator may include a plurality of residual modules connected in series and configured to receive a feature map of a to-be-evaluated image or a feature map processed by an upper level residual module. The to-be-evaluated image is the image historically restored by the generator or a standard image corresponding to the historically restored image, and each residual module includes one or more convolutional layers.

Specifically, the residual modules may include a sampling residual module (resblock) and a down-sampling residual module (resblock down).

The residual modules can be used to extract the features of the input image, and the arrangement of the residual modules is conducive to effectively avoiding gradient disappearance when iteratively updating the weight of the convolutional kernel to deepen the network.

For example, the plurality of residual modules connected in series may include a plurality of cascade-connected down-sampling residual modules and a sampling residual module, and an output of the sampling residual module is the output of the discriminator.

Alternatively, the output of the sampling residual module can be used as the output of the discriminator through a series of processing, such as normalization processing, and so on.

For example, a first down-sampling residual module of the discriminator receives the historically restored image of 256×256 or the corresponding standard image, and the last down-sampling residual module outputs a feature of 4×4×512. The feature of 4×4×512 is output after passing through one sampling residual module, and then becomes a feature vector of 1×1×512 through a global average pooling, and finally is output as the output of the discriminator by a fully connection layer. With this solution, the final output of the discriminator is one number.

Further, the discriminator also includes a self-attention module (Non-Local Block). An input end of the self-attention module is connected with one of the plurality of residual modules to receive the feature map output processed by the residual module. The self-attention module is configured to extract global features of an input feature map, and an output end of the self-attention module is connected with another one of the plurality of residual modules.

For example, the input end of the self-attention module can be connected with an output end of a second residual module, and the output end of the self-attention module can be connected with an input end of a third residual module. In other words, the self-attention module is disposed behind the second down-sampling residual module. At this time, the width and height of the feature map is 64, thus the requirement for computational complexity is moderate and global features can be extracted well.

FIG. 3 shows a structural diagram of one residual module.

Specifically, referring to FIG. 3, the residual module can successively include 4×4 convolutional layers, a normalization module (NormLayer), a linear correction unit (LeayRelu), 4×4 convolutional layers, a normalization module and a linear correction unit.

For example, the normalization module can be an instance normalization module, which can accelerate model convergence and maintain the independence between each image instance.

In the feature map after passing through the linear correction unit, a part greater than zero remains unchanged, and a part less than zero can be multiplied by a preset constant to achieve the purpose of linear correction. The preset constant can be 0.2.

Further, the residual module includes a channel attention module. The channel attention module is configured to perform a weighting process on channels of the input feature map, and the input feature map is a feature map processed by the one or more convolutional kernels of the residual module. Thus, the setting of the channel attention module is beneficial to improve the effect of image restoration.

For example, an input end of the channel attention module can be connected with an output end of the second linear correction unit.

Furthermore, the residual module can also include a sum unit (marked with “+” in the figure). The sum unit includes two inputs, one of which is the output of the channel attention module, and the other of which is quickly connected to the initial input of the residual module. The sum unit adds up two inputs to obtain the output of the residual module.

In some embodiments, the residual module can include two convolutional layers, which is conducive to paying attention to more features.

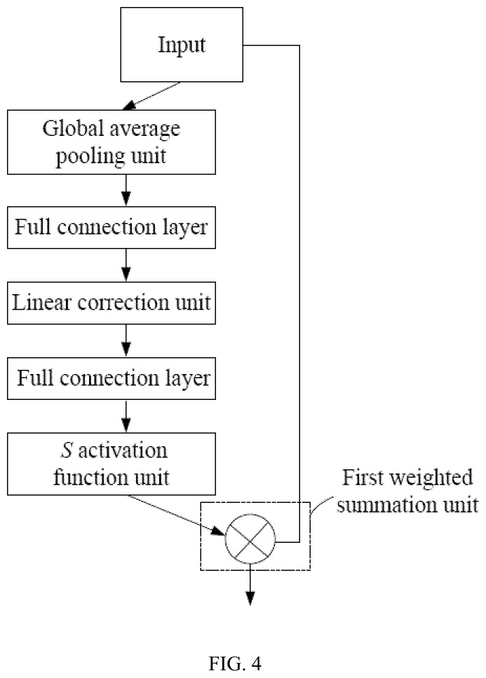

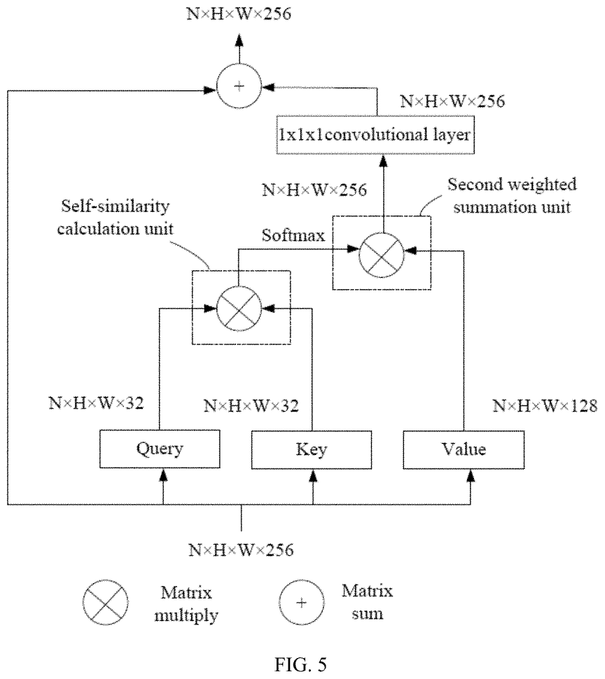

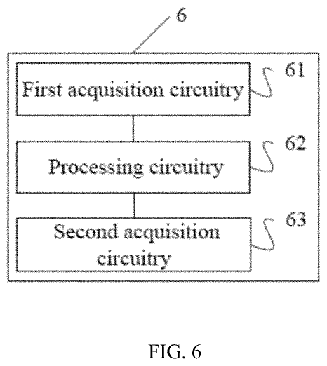

FIG. 4 is a structural diagram of the channel attention module in FIG. 3.

Specifically, referring to FIG. 4, the channel attention module may include a global average pooling unit, a linear correction unit and an s activation function (sigmoid) unit. The global average pooling unit is configured to perform a global average pooling on the input feature map. The linear correction unit is configured to perform linear correction on the feature map after the global average pooling. The s activation function unit is configured to determine a weight of each channel according to the feature map after the linear correction. Adjacent units are connected through a full connection layer.

Furthermore, the channel attention module also includes a first weighted summation unit. The first weighted summation unit is configured to perform a weighted summation on the input feature map according to the weight of each channel determined by the s activation function unit. For example, one of two inputs of the first weighted summation unit is the feature map that is initially input by the channel attention module obtained by a fast connection method, and the other of the two inputs of the first weighted summation unit is the weight of each channel determined by the s activation function unit. The first weighted summation unit performs a weighted summation processing on the initial input feature map based on the weight of each channel to obtain the output result.

FIG. 5 is a schematic structural diagram of the self-attention module.

Referring to FIG. 5, the self-attention module may include a query unit. The query unit is configured to perform convolution on the input processed feature map by a query convolutional kernel to obtain a query convolution processing result. For example, a feature map of N×H×W×256 output by the second residual module is input into the query unit. Assuming that the query convolutional kernel is 1×1×1, the query convolution processing result is N×H×W×32, where N represents the number of input images, W represents the width of the feature map, and H represents the height of the feature map.

The self-attention module may further include a key unit. The key unit is configured to perform convolution on the input processed feature map by a key convolutional kernel to obtain a key convolution processing result. For example, the feature map of N×H×W×256 output by the second residual module is input into the key unit. Assuming that the key convolutional kernel is 1×1×1, the key convolution processing result is N×H×W×32.

The self-attention module may further include a value unit. The value unit is configured to perform convolution on the input processed feature map by a value convolutional kernel to obtain a value convolution processing result. For example, the feature map of N×H×W×256 output by the second residual module is input into the value unit. Assuming that the value convolutional kernel is 1×1×1, the value convolution processing result is N×H×W×128.

The self-attention module may further include a self-similarity calculation unit. The self-similarity calculation unit is configured to calculate a self-similarity degree of the query convolution processing result and the value convolution processing result. For example, after the query convolution processing result is processed by max pooling, the output is N×1/2H×1/2W×32, which is input into the self-similarity calculation unit with the key convolution processing result for calculating the self-similarity degree.

The self-attention module may further include a normalization processing unit. The normalization processing unit is configured to normalize the calculated self-similarity degree based on a preset regression function to obtain a normalized weight. For example, the normalization processing unit may normalize the output of the self-similarity calculation unit by using a softmax function.

The self-attention module may further include a second weighted summation unit. The second weighted summation unit is configured to perform a weighted summation on the value convolution processing result according to the normalized weight to obtain a weighted summation result. For example, according to input parameters of the preceding example, the weighted sum result may be a feature map of N×H×W×256.

Further, the weighted summation result output by the second weighted summation unit is a feature map of N×H×W×256 after the convolution of 1×1×1 convolutional layer.

Further, matrix addition is performed on the feature map of N×H×W×256 output by the 1×1×1 convolutional layer and the feature map of N×H×W×256 initially input by the self-attention module to obtain the final output of the self-attention module, that is, the feature map of N×H×W×256.

Generally speaking, the higher the hierarchical position of the self-attention module in the discriminator, the higher the accuracy of the evaluation result and the more computation.

Embodiments of the present disclosure perform image restoration based on the neural network model, and the convolutional kernel of the neural network model is adjusted according to a historical restoration results to optimize the quality of the restored image output by the generator. Specifically, the process of adjusting the convolutional kernel can at least be implemented in a model training stage according to the quality of the historically restored image of the generator, so as to obtain a generator that is more in line with actual needs. Further, in actual application stage, the convolutional kernel can be further adjusted based on the historically restored images. With the increase of historical data, amount of feedback data for adjusting the convolutional kernel becomes larger and larger, making the adjustment of the convolutional kernel more accurate, which facilitates to improve the restoration quality when performing image restoration based on machine learning.

FIG. 6 is a schematic diagram of an apparatus 6 for image restoration according to an embodiment of the present disclosure. It is understood by those skilled in the art that the apparatus 6 can be used to implement the method according to the embodiments as shown in FIGS. 1 to 5.

Referring to FIG. 6, the apparatus 6 may include a first acquisition circuitry 61, a processing circuitry 62 and a second acquisition circuitry 63. The first acquisition circuitry 61 is configured to acquire a to-be-processed image including biometric information, and to input the to-be-processed image into a generator. The processing circuitry 62 includes the generator. The generator is configured to restore the to-be-processed image and includes a neural network model with a plurality of convolutional layer, and a weight of a convolutional kernel of the generator is determined at least according to a quality of an image historically restored by the generator. The second acquisition circuitry 63 is configured to acquire a restored image output by the generator.

More details on working principles and working methods of the apparatus 6 may be referred to related descriptions with reference to FIGS. 1 to 5, and are not described in detail here.

Furthermore, another embodiment of the present disclosure provides a storage medium. The storage medium has computer instructions stored therein, and the computer instructions are executed to perform steps of the method according to the embodiments as shown in FIGS. 1 to 5. In some embodiments, the storage medium may include a computer readable storage medium, such as a non-volatile memory or a non-transitory memory. The computer readable storage medium may include a Read Only Memory (ROM), a Random Access Memory (RAM), a magnetic disk or an optical disk.

Furthermore, another embodiment of the present disclosure provides a terminal including a memory and a processor. The memory is stored with computer instructions executable on the processor, and the computer instructions are executed by the processor to perform steps of method according to the embodiments as shown in FIGS. 1 to 5. In some embodiment, the terminal may be an intelligent device, such as a mobile phone, an iPad, etc.

Although the present disclosure has been disclosed above, the present disclosure is not limited thereto. Any changes and modifications may be made by those skilled in the art without departing from the spirit and scope of the present disclosure, and the scope of the present disclosure should be determined by the appended claims.

1. A method for image restoration, comprising:
acquiring a to-be-processed image, wherein the to-be-processed image comprises biometric information;
inputting the to-be-processed image into a generator, wherein the generator comprises a neural network model with a plurality of convolutional layers, and a weight of a convolutional kernel of the generator is determined at least according to a quality of an image historically restored by the generator; and
restoring the to-be-processed image by the generator to acquire a restored image.

2. The method according to claim 1, wherein determining a weight of a convolutional kernel of the generator at least according to a quality of an image historically restored by the generator comprises:
updating the weight of the convolutional kernel of the generator according to an evaluation result of a discriminator on the image historically restored by the generator, wherein the discriminator comprises a neural network model with a plurality of convolutional layers.

3. The method according to claim 2, wherein there is a connection relationship among the plurality of convolutional layers of the neural network model of the generator and/or the plurality of convolutional layers of the neural network model of the discriminator.

4. The method according to claim 2, wherein updating the weight of the convolutional kernel of the generator according to an evaluation result of a discriminator on the image historically restored by the generator comprises:
acquiring the image historically restored by the generator;
inputting the historically restored image into the discriminator;
acquiring a first evaluation result of the discriminator on the historically restored image; and
updating the weight of the convolutional kernel of the generator at least according to a loss function of the generator and the first evaluation result.

5. The method according to claim 4, wherein the loss function of the generator comprises an adversarial loss function and an L1 loss function, and updating the weight of the convolutional kernel of the generator at least according to the loss function of the generator and the first evaluation result comprises:
calculating a first output value according to the first evaluation result and the adversarial loss function of the generator;
calculating a second output value according to the historically restored image, a standard image corresponding to the historically restored image and the L1 loss function; and
updating the weight of the convolutional kernel of the generator according to the first output value and the second output value.

6. The method according to claim 5, wherein calculating a first output value according to the first evaluation result and the adversarial loss function of the generator comprises:
calculating the first output value based on following formula:
$${L}_{g\_adv} = {max}_{G} ( {E}_{z ∼ p ( z )} [ D ( G ( z ) ) ] ) ;$$
wherein L_{g_adv} represents the first output value,
$${max}_{G} ( )$$
represents a value of G when the function of E_{z˜p(z)}[D(G(z))] has a maximum value, G represents the generator, the value of G calculated based on the above formula is the first output value; E_{z˜p(z)}(u) represents a mean value of a function u when z obeys P(z), p(z) represents a distribution of the historically restored image, z represents the to-be-processed image, D(G(z)) represents the first evaluation result, and G(z) represents the historically restored image.

7. The method according to claim 5, wherein calculating a second output value according to the historically restored image, a standard image corresponding to the historically restored image and the L1 loss function comprises:
calculating the second output value based on following formula:
L₁=∥x−G(z)∥₁;
wherein L1 represents the second output value, x represents the standard image, z represents the to-be-processed image, and G(z) represents the historically restored image.

8. The method according to claim 2, further comprising:
updating the weight of the convolutional kernel of the discriminator according to an evaluation result of the discriminator on the image historically restored by the generator and a standard image corresponding to the historically restored image.

9. The method according to claim 8, wherein updating the weight of the convolutional kernel of the discriminator according to an evaluation result of the discriminator on the historically restored image by the generator and a standard image corresponding to the historically restored image comprises:
acquiring the image historically restored by the generator and the corresponding standard image;
inputting the historically restored image into the discriminator to obtain a first evaluation result, and inputting the standard image into the discriminator to obtain a second evaluation result; and
calculating a third output value at least according to an adversarial loss function of the discriminator, the first evaluation result and the second evaluation result; and
updating the weight of the convolutional kernel of the discriminator according to the third output value.

10. The method according to claim 9, wherein calculating a third output value at least according to an adversarial loss function of the discriminator, the first evaluation result and the second evaluation result comprises:
calculating the third output value based on following formula:
$${L}_{d\_adv} = {min}_{D} ( {E}_{x ∼ q ( x )} [ max ( 0 , 1 - D ( x ) ) ] + {E}_{z ∼ p ( z )} [ max ( 0 , 1 + D ( G ( z ) ) ) ] ) + λ {{E}_{\hat{I} ∼ p \hat{I}} ( {( ‖ {∇}_{\hat{I}} D ( \hat{I} ) ‖ )}^{2} - 1 )}^{2} ;$$
wherein L_{d_adv} represents the third output value,
$${min}_{D} ( )$$
represents a value of D when the function of E_{x˜q(x)}[max(0,1−D(x))]E_{z˜p(z)}[max(0,1+D(G(z)))] has a minimum value, D represents the discriminator, the value of D calculated based on the above formula represents the third output value, E_{x˜q(x)}(u) represents a mean value of a function u when x obeys q(x), q(x) represents a distribution of the standard image, x represents the standard image, E_{z˜p(z)}(u) represents a mean value of the function u when z obeys p(z), p(z) represents a distribution of the historically restored image, z represents the to-be-processed image, D(x) represents the second evaluation result, D(G(z)) represents the first evaluation result, G(z) represents the historically restored image, λ represents a preset hyperparameter, ∇( ) represents a gradient penalty function, Î represents an interpolation function between the distribution of q(x) and the distribution of p(z), and ∇_{Î}D(Î) represents a gradient penalty of the discriminator by the interpolation function Î between the distribution of q(x) and the distribution of p(z).

11. The method according to claim 8, wherein updating the weight of the convolutional kernel of the generator and updating the weight of the convolutional kernel of the discriminator are performed several times.

12. The method according to claim 2, wherein the discriminator comprises:
a plurality of residual modules connected in series and configured to receive a feature map of a to-be-evaluated image or a feature map processed by an upper level residual module, wherein the to-be-evaluated image is the image historically restored by the generator or a standard image corresponding to the historically restored image, and each residual module comprises one or more convolutional layers; and
a self-attention module having an input end connected with a residual module of the plurality of residual modules to receive the feature map processed by the residual module, wherein the self-attention module is configured to extract global features of an input feature map, and an output end of the self-attention module is connected with another residual module of the plurality of residual modules.

13. The method according to claim 12, wherein one or more of the plurality of residual modules comprise:
a channel attention module configured to perform a weighting process on channels of the input feature map, and the input feature map is a feature map processed by the one or more convolutional kernels of the residual module.

14. The method according to claim 13, wherein the channel attention module comprises:
a global average pooling unit configured to perform a global average pooling on the input feature map;
a linear correction unit configured to perform a linear correction on the feature map on which the global average pooling has been performed; and
an s activation function unit configured to determine a weight of each channel according to the feature map on which the linear correction has been performed;
wherein adjacent units are connected through a full connection layer.

15. The method according to claim 14, wherein the channel attention module further comprises:
a first weighted summation unit configured to perform a weighted summation on the input feature map according to the weight of each channel determined by the s activation function unit.

16. The method according to claim 12, wherein the self-attention module comprises:
a query unit configured to perform convolution on the input processed feature map by a query convolutional kernel to obtain a query convolution processing result;
a key unit configured to perform convolution on the input processed feature map by a key convolutional kernel to obtain a key convolution processing result;
a value unit configured to perform convolution on the input processed feature map by a value convolutional kernel to obtain a value convolution processing result;
a self-similarity calculation unit configured to calculate a self-similarity degree of the query convolution processing result and the value convolution processing result;
a normalization processing unit configured to normalize the calculated self-similarity based on a preset regression function to obtain a normalized weight; and
a second weighted summation unit configured to perform weighted summation on the value convolution processing result according to the normalized weight to obtain a weighted summation result, wherein the output of the self-attention module is generated according to the weighted summation result.

17. The method according to claim 1, wherein the generator processes the to-be-processed image based on partial convolution and/or LBAM.

18. An apparatus for image restoration, comprising:
a first acquisition circuitry configured to: acquire a to-be-processed image, wherein the to-be-processed image comprises biometric information, and to input the to-be-processed image into a generator; and
a processing circuitry comprising the generator, wherein the generator is configured to restore the to-be-processed image and comprises a neural network model with a plurality of convolutional layers, and a weight of a convolutional kernel of the generator is determined at least according to a quality of an image historically restored by the generator.

19. A non-transitory storage medium having computer instructions stored therein, wherein the computer instructions are executed to perform steps of the method according to claim 1.

20. A terminal comprising a memory and a processor, wherein the memory is stored with computer instructions executable on the processor, and the computer instructions are executed by the processor to perform steps of the method according to claim 1.
